(19) United States
(12) Patent Application Publication
(10) Pub. No.: US 2007/0046052 A1
(43) Pub. Date: Mar. 1, 2007

(54) An improved automatic holding device

(75) Inventors: Ching Shih Liu, Lungtan, Taoyuan (TW); Kang Neng Perng, Lungtan, Taoyuan (TW); Kang Lin Hwang, Lungtan, Taoyuan (TW)

Correspondence Address: MICHAEL LIN, 5F 79 Roosevelt Rd. Sec. 2, TAIPEI, 106, TW

(73) Assignee: INSTITUTE OF NUCLEAR ENERGY RESEARCH, Lungtan (TW)

(21) Appl. No.: 11/162,072

(22) Filed: Aug. 27, 2005

(51) Int. Cl. B25J 15/00

(52) U.S. Cl. 294/116

(57) ABSTRACT

An improved automatic holding device utilizes a remote operating lever to carry out forward and reverse turning and control the hooks of two-hook gripper for ease and efficiency of the operation, comprising an inner base, a threaded sleeve and a two-hook gripper; wherein said inner base having a near inverted-U shape cross section, a center bolt at its topside, and a tapped bore at corners of the inner base at both sides of the center bolt; the threaded sleeve is associated with the center bolt of the inner base, the outer surface of upper portion of the threaded sleeve has external thread, and the lower portion of the threaded sleeve is a gradually downward enlarged cone portion; and the middle part of two-hook gripper has a transversal axle hole for insertion of pin-jointed element into the tapped bore of the inner base, while provides a recess bevel at both inner side of upper part of the two-hook gripper for contact with the cone portion of the threaded sleeve, and each inner side of lower part of the two-hook gripper has an opposite hook respectively.

### FIELD OF THE INVENTION

The invention relates to an improved automatic holding device, in particularly, to a simple device to perform gripping, releasing and predetermined tasks.

### BACKGROUND OF THE INVENTION

Conventional remote control gripping apparatus has a mechanism for gripping explosives as used by bomb disposal team of police department; it has an open-and-close hook at the leading end of rod-shaped long arm, and control device provide at the distal end; the control device connect hook with rope or signal wire inside the rod for control open-close motion of the hook in order to hold said desired object (such as explosives etc.); however, the major parts of above remote control gripping apparatus are binding together as a whole and non-collapsible when use; this is extremely inconvenient for handling while it is not in use, and substantial modifications is therefore necessary.

In view of above disadvantages of the conventional remote control gripping apparatus, inventor envisages those disadvantages and engages in solving those problems as to create the present invention.

### SUMMARY OF THE INVENTION

The object of this present invention is to provide an improved automatic holding device, it consists essentially an inner base, a threaded sleeve and a two-hook gripper; wherein said inner base having a near inverted-U shape cross section, a center bolt at its topside, and a transverse tapped bore at corners of the inner base at both sides of the center bolt; said threaded sleeve is associated with the center bolt of the inner base, the outer surface of upper portion of the threaded sleeve has external thread, and the lower portion of the threaded sleeve is a gradually downward enlarged cone portion, and the middle part of two-hook gripper has a transversal axle hole for insertion of a pivot bolt into the transverse tapped bore of the inner base, while provides a bevel opposed to recess of the upper two-hook gripper for contact with the cone of threaded sleeve, it also provides a hook opposed to the inner side of lower two-hook gripper; at operation, a remote operating lever which has a screw tapped bore mated with said threaded sleeve may axially slide and reach at the [[end]] top surface of said two-hook gripper, and pushing or retracting of the remote operation lever at the top surface of said two-hook gripper will cuase hooks of two-hook gripper pivotally rotate and change corresponding position on both sidewalls of the inner base to perform a grip or release action of desired object.

The main object of the present invention is to provide a detachable operation with a remote operating lever for use in various applications.

Another object of the present invention of an improved automatic holding device is to utilize a remote operating lever to carry out forward and reverse turning and control the hooks of two-hook gripper for ease and efficiency of the operation.

The above and other detail structure, applications, features and other advantages of the present invention will be more clearly understood from the following detailed description taken in conjunction with the accompanying drawings.

### BRIEF DESCRIPTION OF THE DRAWINGS

FIG. 1 is an exploded view of the present invention.

FIG. 2 is an assembly schematic diagram of the present invention.

FIG. 3 is an operational schematic diagram (1) of the present invention.

FIG. 4 is an operational schematic diagram (2) of the present invention.

FIG. 5 is an operational schematic diagram (3) of the present invention.

### DETAILED DESCRIPTION OF THE PREFERRED EMBODIMENTS

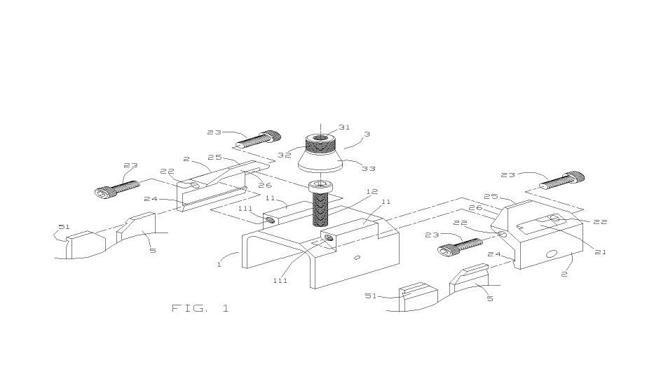

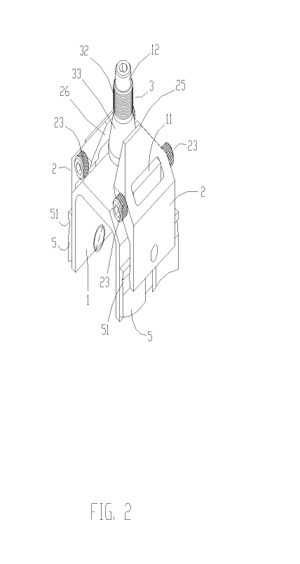

FIG. 1 is an exploded view of the present invention, in conjunction with schematic diagram of FIG. 2 shows this invention apparently comprising: an inner base 1, a two-hook gripper 2 and a threaded sleeve 3; wherein said inner base 1 has a near inverted-U shape cross section, its center of topside combined with a center bolt 12 extending upward, and each side corner has a projections 11, a transverse tapped bore 111 is located at the middle of projections 11; a hollow area 21 fit for projections 11 of the inner base 1 is located at the middle of two-hook gripper 2; an axle hole 22 is provided transversely at both sides of hollow area 21, it allows pivot bolt 23 passing through and coupling with the tapped bore 111 of projections 11; there is a top surface 25 on upper end of two-hook gripper 2, on opposed side of both top surface 25 have a recess bevel 26, and on the both inner side of lower two-hook gripper 2 have a protruded hook 24; the center of said threaded sleeve 3 provides a tapped bore 31 for coupling with center bolt 12 of said inner base 1; the outer surface of upper threaded sleeve 3 has external thread 32, and the lower threaded sleeve 3 is a gradually downward enlargement cone 33 for contact the bevel 26 of two-hook gripper 2.

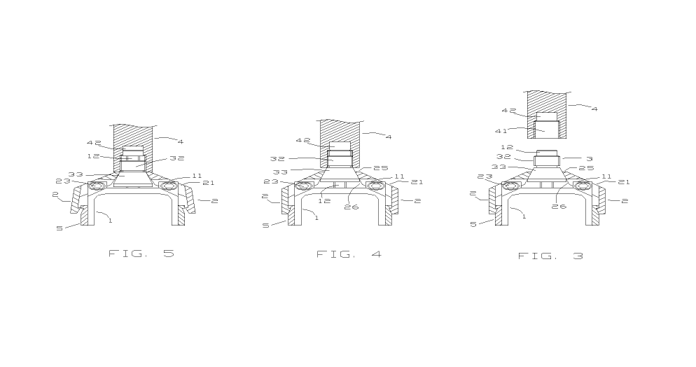

FIG. 3 to 5 are operational schematic diagrams of the present invention; the drawings show the present invention can grasp each hook 51 of the desired object 5 independently between the hook 24 of two-hook gripper 2 and two sidewalls of the inner base 1; when implementation, external thread 32 of threaded sleeve 3 is coupling with one end of remote operating lever 4 has tapped bore 41, this will drive threaded sleeve 3 axial slide on center bolt 12; top center bolt 12 is extended upward and is received by an accommodation chamber 42 in the tapped bore 41; when the remote operating lever 4 push down at the [[end]] top surface 25 of two-hook gripper 2, it will stretch out hooks at the other end of two-hook gripper 2 and release said desired object at the same time; reverse turning said remote operating lever 4 if wish return to grip state; therefore, by way of above method it can performs gripping and releasing operations at any time.

From above description, the improved automatic holding device substantially provides characteristics of simple operation and steady holding, thus meet the requirement of applicability, novelty and inventiveness in the industry.

Accordingly, the preferred embodiments abovementioned are intended to illustrate and not limit the scope of the invention. All equivalents and modifications according to the appended claims are within the scope of the present invention.

What is claimed is:

1. An improved automatic holding device includes:
an inner base having a near inverted-U shape cross section, a center bolt at its topside, and a transverse tapped bore at corners of the inner base at both sides of the center bolt;
a threaded sleeve, which is located at center bolt of the inner base outer surface of upper part of the threaded sleeve has external thread, and lower part of the threaded sleeve is a gradually downward enlarged cone portion; and
a two-hook gripper, which has a transversal axle hole at its middle section for insertion of a pivot bolt into the transverse tapped bore of the inner base, provides a recess bevel at inner sides of upper part of the two-hook gripper for contact with a cone of threaded sleeve, and each inner side of lower part of the two-hook gripper is furnished with a protruded hook in opposite with each other;
wherein a desired object can be held by the protruded hooks of said two-hook gripper in adjacent to both sidewalls of the inner base, a remote operating lever which has a screw tapped bore mated with said threaded sleeve may axially slide and reach at top surface of said two-hook gripper, and pushing or withdrawing of the remote operating lever at the top surface of said two-hook gripper may stretch out or retract back the hook of two-hook gripper to release or grip the desired object.

2. An improved automatic holding device according to claim 1, wherein each side corner of said top inner base has a projection, the transverse tapped bore is located at middle of projection, and a hollow area is located at corresponding middle of two-hook gripper to prevent interference while the two-hook gripper pivotally rotates.
